(19) United States
(12) Patent Application Publication
(10) Pub. No.: US 2018/0347399 A1
(43) Pub. Date: Dec. 6, 2018

(54) TURBINE SHROUD WITH INTEGRATED HEAT SHIELD

(71) Applicant: PRATT & WHITNEY CANADA CORP., Longueuil (CA)

(72) Inventors: Remy SYNNOTT, St-Jean-sur-Richelieu (CA); John PIETROBON, Outremont (CA); Franco DI PAOLA, Montreal Nord (CA)

(21) Appl. No.: 15/611,018

(22) Filed: Jun. 1, 2017

(51) Int. Cl. F01D 25/14; F01D 9/04; F01D 25/12; F01D 25/24; F01D 5/02; F01D 11/00

(52) U.S. Cl. CPC F01D 25/145; F01D 9/04; F01D 25/12; F01D 25/24; F05D 2260/231; F01D 11/005; F05D 2220/32; F05D 2240/14; F01D 5/02

(57) ABSTRACT

A turbine shroud segment forms part of a circumferentially segmented shroud assembly surrounding a circumferential array of turbine blades of a gas turbine engine. The turbine shroud segment has a platform extending axially from an upstream end portion to a downstream end portion relative to a flow of gas through the gas turbine engine. A heat shield extension projects radially inwardly and in an upstream direction from the upstream end portion of the platform.

### TECHNICAL FIELD

The application relates generally to gas turbine engines and, more particularly, to turbine shrouds.

### BACKGROUND OF THE ART

Turbine blade tip shrouds are typically radially located on a turbine support case about the tip of the turbine blades to control blade tip clearance. In order to preserve its mechanical properties, the turbine support case needs to be protected from the hot gas flowing across the turbine blades.

### SUMMARY

Therefore, in one aspect of the present disclosure, there is provided a turbine shroud segment forming part of a circumferentially segmented shroud assembly surrounding a circumferential array of turbine blades of a gas turbine engine; the turbine shroud segment comprising: a platform extending axially from an upstream end portion to a downstream end portion relative to a flow of gas through the gas turbine engine, and a heat shield extension projecting radially inwardly and in an upstream direction from the upstream end portion of the platform

In another aspect, there is provided a turbine section of a gas turbine engine, the turbine section comprising: a turbine support case extending about an axis; a circumferential array of turbine blades disposed within the turbine support case for rotation about the axis; and a circumferentially segmented turbine shroud mounted to the turbine support case about the circumferential array of turbine blades, the circumferentially segmented turbine shroud comprising a plurality of shroud segments disposed circumferentially one adjacent to another, each shroud segment having a platform extending axially from an upstream end portion to a downstream end portion relative to a flow of gas through the turbine section, each shroud segment further having a heat shield extension projecting radially inwardly and in an upstream direction from the upstream end portion of the platform to a location upstream of the circumferential array of turbine blades.

In a further aspect, there is provided a method of thermally protecting a turbine support case surrounding a hot gas path: comprising defining a cooling cavity on a gas path facing side of the turbine support case, and controlling a bleeding of cooling air from the cooling cavity into the hot gas path with a gap defined between a heat shield extension of a circumferentially segmented turbine shroud and an adjacent turbine shroud structure.

### DESCRIPTION OF THE DRAWINGS

Reference is now made to the accompanying figures in which:

FIG. 1 is a schematic cross-section view of a gas turbine engine;

FIG. 2 is a schematic cross-section view of a turbine section of the gas turbine engine shown in FIG. 1 and illustrating a shroud segment having a heat shield extension configured to seal a radial gap;

FIG. 3 is a schematic cross-section view of the turbine section illustrating another embodiment of a shroud segment having a heat shield extension configured to seal an axial gap; and

FIG. 4 is a schematic cross-section view of the turbine section illustrating a further embodiment of a shroud segment cooperating with a W-seal to seal an axial gap.

### DETAILED DESCRIPTION

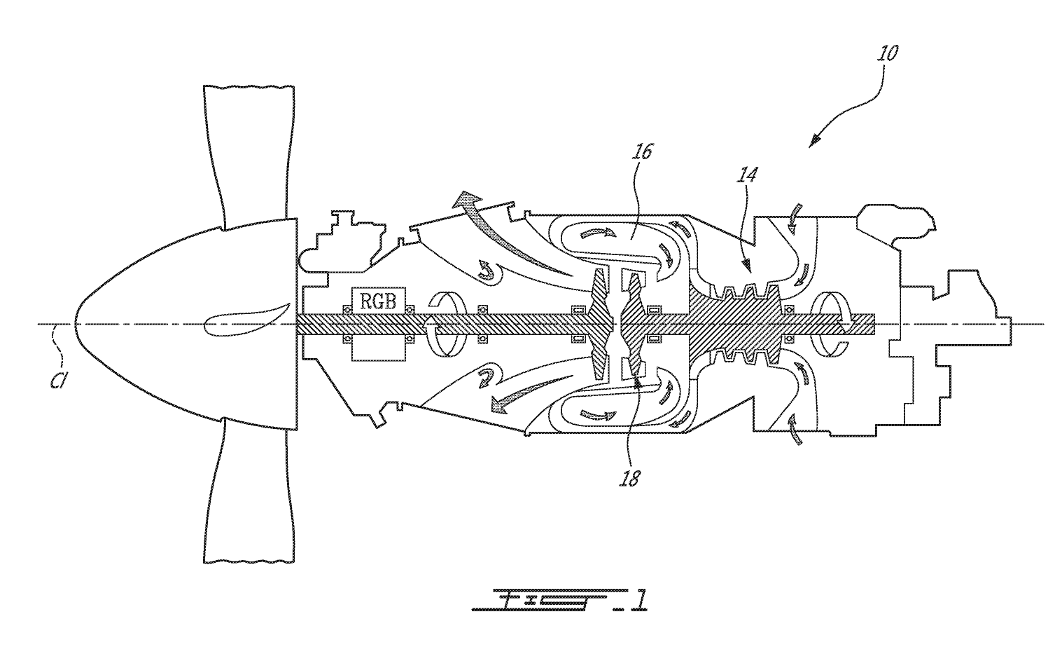

FIG. 1 illustrates a gas turbine engine 10 of a type preferably provided for use in subsonic flight, generally comprising in serial flow communication a compressor section 14 for pressurizing the air, a combustor 16 in which the compressed air is mixed with fuel and ignited for generating an annular stream of hot combustion gases, and a turbine section 18 for extracting energy from the combustion gases.

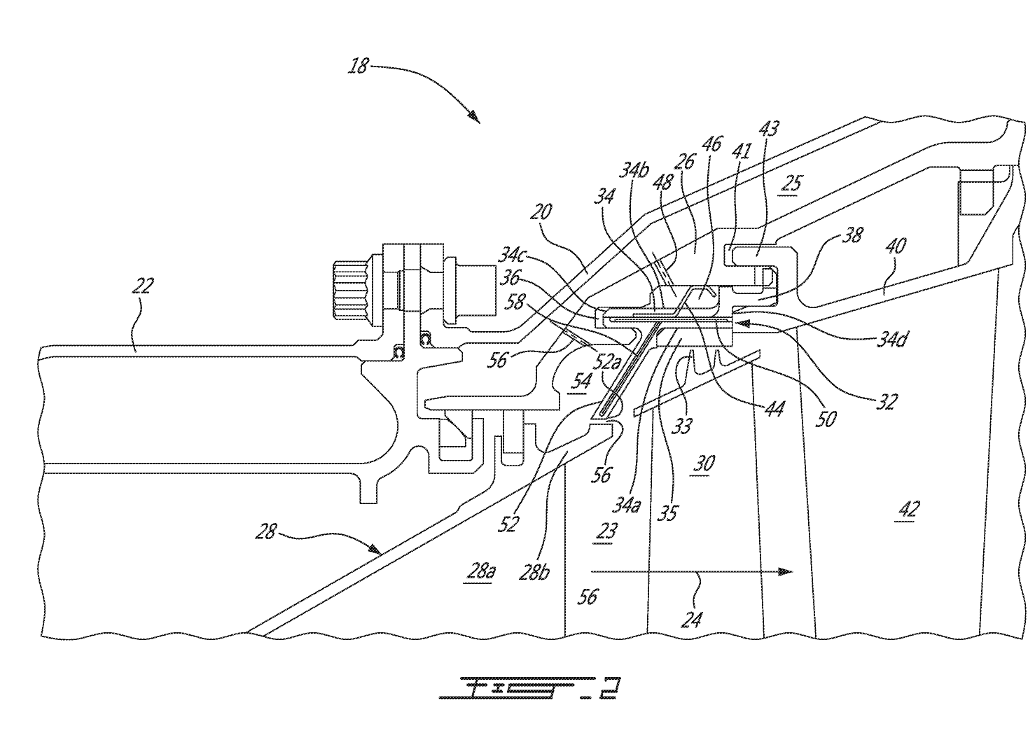

As shown in FIG. 2, the turbine section 18 comprises an outer case 20 bolted at an upstream end thereof to a gas generator case 22. The upstream direction is herein defined with respect to the flow of hot gas flowing through the gas path 23 of the turbine section 18, as schematically depicted by flow arrow 24. The turbine section 18 further comprises a turbine support case 26 (also herein referred to as the inner case) concentrically mounted inside the outer case 20. The outer case 20 and the inner case 26 are centrally mounted with respect the engine centerline (CI) shown in FIG. 1. According the illustrated embodiment, an annular plenum 25 is defined between the outer case 20 and the inner case 26. The annular plenum 25 is connected to a source of cooling air (e.g. compressor bleed air) to provide cooling to the outer and inner cases 20 and 26.

The turbine section 18 further comprises a vane ring 28 including an array of circumferentially spaced-apart vanes 28a. In one embodiment, the vane ring 28 is provided in the form of a full ring. However, it is understood that the vane ring 28 could be circumferentially segmented to reduce thermal stress. A turbine rotor including an array of circumferentially spaced-apart turbine blades 30 is disposed immediately downstream of the vane ring 28 for extracting power from the flow of hot gases received from vanes 28a. The turbine rotor is housed within the inner case 26. A turbine blade tip shroud 32 (also herein referred to as a turbine shroud) is radially located on the inner case 26 around the tip of the turbine blades 30. According to the illustrated embodiment, the turbine shroud 32 is circumferentially segmented into a plurality of segments assembled on the inner case 26 to form a complete ring about the turbine blades 30. Each shroud segment has a platform 34 having a hot gas path side surface 34a and an opposed back surface 34b extending axially from an upstream end 34c to a downstream end 34d and circumferentially between opposed axially extending edges. The platform 34 defines a curvature in the circumferential direction to allow the shroud segments to collectively define a ring about the turbine blades 30. A layer of abradable material 35 may be provided on the hot gas path side surface 34a of the platform 34 in closed facing relationship with sealing fins 33 extending radially outwardly from the tip of the turbine blades 30. The fins 33 and the layer of abradable material 35 cooperate to improve control tip clearance and, thus, minimize hot combustion gas leakage over the tip of the turbine blades 30.

As can be appreciated from FIG. 2, the upstream end 34c of the shroud platform 34 is axially slidably received in an axially rearwardly open groove 36 defined in the hot gas path facing side (i.e. the radially inner side) of the inner case 26. The downstream end 34d of the platform 34 may be provided on the back surface 34b thereof with an axially extending leg 38 for axial sliding engagement with the back surface of an upstream end of a shroud platform 40 of a downstream row of turbine vanes 42 having a front hook 43 adapted to be axially slidably engaged in a corresponding axially rearwardly open groove 41 defined in the radially inner surface of the inner case 26.

One or more biasing members 44, such as springs or the like, may be provided between the inner case 26 and the platform 34 of the shroud segments to spring load or urge the shroud segments radially inwardly in contact with the inner lip of groove 36 and the back surface of the shroud platform 40 of the downstream stage of vanes 42.

Still referring to FIG. 2, it can be seen that the biasing member(s) is/are disposed in a cavity 46 defined between the turbine shroud 32 and the inner case 26. A set of cooling holes 48 (only one shown in FIG. 2) is defined through the inner case 26 to direct cooling air from the annular plenum 25 into the cavity 46, thereby providing cooling to the turbine shroud 32. Feather seals 50 may be provided between each pair of circumferentially adjacent shroud segments. The feather seals 50 may be installed in grooves defined in the axially extending sides of the platform 34 of circumferentially adjacent shroud segments to seal the cooling cavity 46 from the hot gas path 23.

According to one embodiment, the inner case 26 is also configured to act as a blade containment device. In order to preserve the mechanical properties of the inner case for blade containment, the inner case 26 needs to be protected from the hot gas flowing through the gas path 23. To that end, it is herein proposed to provide the shroud segments with heat shield extensions 52. Each shroud segment and associated heat shield extension 52 are of unitary construction and can be machined from a solid block of material. The heat shield extensions 52 project radially inwardly and in an upstream direction from an upstream end portion of the platforms 34 of the associated shroud segments to jointly form a complete heat shield ring structure (i.e. a full 360 degrees segmented heat shield ring). Since this part is segmented, the hoop is removed and the thermal stress in the part is reduced substantially. This results in improved durability as compared to a full heat shield ring.

In the exemplary embodiment shown in FIG. 2, the heat shield extension 52 of each shroud segment projects from the radially inner gas path side surface of the shroud platform 34 from a location upstream of the layer of abradable material 35 (i.e. upstream of the fins 33) to a free distal end upstream of the turbine blades 30. Still according to the embodiment of FIG. 2, the heat shield extensions 52 cooperate with the radially outer shroud platform 28b of the vane ring 28 to form a cooling plenum or cavity 54 on the radially inner side of the inner case 26 upstream of the turbine blades 30. One or more holes 56 are defined through the inner case 26 for directing cooling air radially inwardly from the outer plenum 25 into the inner cooling cavity 54. The heat shield extensions 52 are provided at respective distal ends thereof with a radial sealing face or gap control face 52a configured to cooperate with a radially outer surface at the downstream end of the radially outer shroud platform 28b of vane ring 28 to seal the cooling cavity 54 from the hot gas path. The heat shield extensions 52 are configured and positioned relative to the vane ring 28 so that in running conditions, the difference in thermal expansion between the vane ring 28 (which is hotter), the turbine shroud and the inner case 26 (the cooler component) closes the radial gap 56 between the heat shield extensions 52 and the radially outer shroud platform 28b of the vane ring 28. The shroud segments thus perform two functions: 1) provide acceptable tip clearance and 2) act as a segmented heat shield to thermally protect the turbine support case 26.

The cooling air in the cooling cavity 54 is provided at a pressure greater than the pressure prevailing in the hot gas path 23, thereby preventing hot gas ingestion through the radial gap 56 at the interface between the heat shield extensions 52 and the radially outer surface of the radially outer shroud platform 28b of the vane ring 28. The amount of cooling air allowed to seep through the sealing interface into the gas path 23 is controlled by the radial gap 56, which acts as a metering orifice. As shown in FIG. 2, feather seals 58 could also be provided between each pair of circumferentially adjacent heat shield extensions 52 to prevent cooling air from escaping from between adjacent heat shield extensions 52.

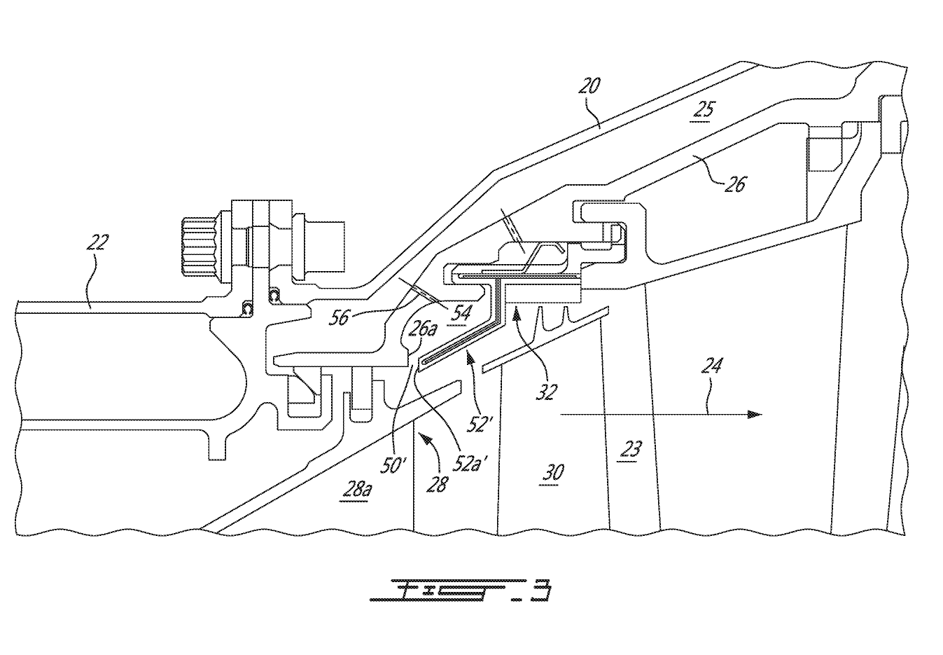

Now referring to FIG. 3, it can be appreciated that the heat shield extensions 52′ can also be configured to axially seal or close against the inner case 26 rather than radially seal or close against the upstream vane ring 28 as shown in FIG. 2. Indeed, according to this variant, the cooling air cavity 54 is defined by the inner case 26 and the heat shield extensions 52′. According to this variant, the heat shield extensions 52′ have a greater axial component extending further in the upstream direction in order to close an axial gap 56′ when the engine is in running condition. The heat shield extensions 52′ have an axial sealing or gap control face 52a′ disposed in closed facing relationship with a rearwardly axially facing face 26a provided on the gas path side of the inner case 26.

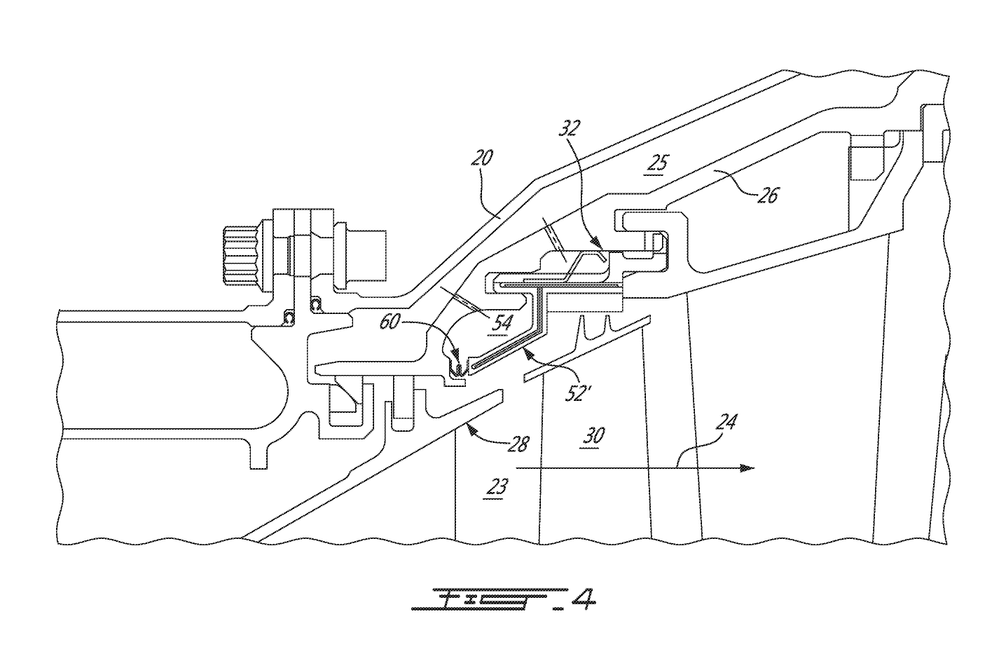

Referring to FIG. 4, it can be seen that an axially compressible seal 60 can be installed in the axial gap 56′ to improve sealing. The seal 60 may, for instance, be provided in the form of an annular seal having a W-shaped cross-section. It is noted that a seal could also be installed in the radial gap shown in FIG. 2.

The above description is meant to be exemplary only, and one skilled in the art will recognize that changes may be made to the embodiments described without departing from the scope of the invention disclosed. For example, it is understood that the heat shield segments could cooperate with adjacent engine structures other than the exemplified upstream vane ring and inner case. It is also under stood that the cooling air cavity on the gas path side of the inner case could be connected to any suitable source of coolant and is thus not limited to being fluidly coupled to the outer plenum. Still other modifications which fall within the scope of the present invention will be apparent to those skilled in the art, in light of a review of this disclosure, and such modifications are intended to fall within the appended claims.

1. A turbine shroud segment forming part of a circumferentially segmented shroud assembly surrounding a circumferential array of turbine blades of a gas turbine engine; the turbine shroud segment comprising: a platform extending axially from an upstream end portion to a downstream end portion relative to a flow of gas through the gas turbine engine, and a heat shield extension projecting radially inwardly and in an upstream direction from the upstream end portion of the platform.

2. The turbine shroud segment as defined in claim 1, wherein the heat shield extension is provided at a distal end thereof with a sealing face configured to cooperate with an adjacent engine structure to seal an air plenum upstream of the circumferential array of turbine blades.

3. The turbine shroud segment as defined in claim 2, wherein the sealing face is a radial sealing face.

4. The turbine shroud segment as defined in claim 2, wherein the sealing face is an axial sealing face.

5. The turbine shroud segment as defined in claim 1, wherein the platform has a radially inner gas path surface including a layer of abradable material, the layer of abradable material disposed downstream of the heat shield extension.

6. A turbine section of a gas turbine engine, the turbine section comprising: a turbine support case extending about an axis; a circumferential array of turbine blades disposed within the turbine support case for rotation about the axis; and a circumferentially segmented turbine shroud mounted to the turbine support case about the circumferential array of turbine blades, the circumferentially segmented turbine shroud comprising a plurality of shroud segments disposed circumferentially one adjacent to another, each shroud segment having a platform extending axially from an upstream end portion to a downstream end portion relative to a flow of gas through the turbine section, each shroud segment further having a heat shield extension projecting radially inwardly and in an upstream direction from the upstream end portion of the platform to a location upstream of the circumferential array of turbine blades.

7. The turbine section defined in claim 6, wherein the heat shield extensions seal a cooling air cavity on a radially inner side of the turbine support case.

8. The turbine section defined in claim 7, wherein at least one cooling air feed hole extends through the turbine support case to fluidly connect the cooling air cavity to a source of cooling air.

9. The turbine section defined in claim 7, wherein the cooling air cavity is at least in part defined by the turbine support case and the heat shield extensions.

10. The turbine section defined in claim 7, wherein each heat shield extension is provided at a distal end thereof with a sealing face adapted, in engine running condition, to close a gap between the cooling air plenum and a main gas path section of the turbine section.

11. The turbine section defined in claim 10, further comprising a vane ring upstream of the circumferential array of turbine blades, wherein the gap is a radial gap between the heat shield extensions and the vane ring.

12. The turbine section defined in claim 10, wherein the gap is a radial gap, and wherein the sealing face is a radial sealing face cooperating with an adjacent engine structure upstream of the circumferential array of turbine blades to seal the cooling air cavity.

13. The turbine section defined in claim 10, wherein the gap is an axial gap between the turbine support case and the heat shield extensions.

14. The turbine section defined in claim 13, wherein an axially compressible seal is disposed in the axial gap.

15. The turbine section defined in claim 6, wherein feather seals are provided between each pair of circumferentially adjacent heat shield extensions.

16. A method of thermally protecting a turbine support case surrounding a hot gas path: comprising defining a cooling cavity on a gas path facing side of the turbine support case, and controlling a bleeding of cooling air from the cooling cavity into the hot gas path with a gap defined between a heat shield extension of a circumferentially segmented turbine shroud and an adjacent turbine shroud structure.

17. The method of claim 16, wherein the heat shield extension extends radially inwardly and in an upstream direction from a radially inner surface of the circumferentially segmented turbine shroud.

18. The method of claim 16, comprising using thermal expansion to cause the gap to close in running condition.

19. The method of claim 18, wherein the gap is a radial gap, and wherein the heat shield extension projecting from the circumferentially segmented turbine shroud cooperates with an upstream turbine vane ring to close the radial gap in running condition.
